(19) United States
(12) Patent Application Publication
(10) Pub. No.: US 2006/0285430 A1
(43) Pub. Date: Dec. 21, 2006

(54) Method of homogenizing microvolume liquid and apparatus therefor

(75) Inventor: Yoshihiro Seto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/455,685

(22) Filed: Jun. 20, 2006

(30) Foreign Application Priority Data
Jun. 20, 2005 (JP) 2005-179742

(51) Int. Cl. B01F 5/00

(52) U.S. Cl. 366/163.1

(57) ABSTRACT

In a method of homogenizing micro-volume liquid, a first liquid and then a second liquid is sucked into the suction nozzle. The sucked first and second liquids are sent to a nozzle end, to form a pool of a mixed liquid of the first and second liquids at the nozzle end. According to the inertia, the mixed liquid gets so fluid in the pool that the first and second liquids are stirred in the pool. Thereafter, the pool of the mixed liquid is sucked into a liquid channel. According to the kinds of liquids to be mixed, the number of times to form the pool is predetermined. The steps of forming the pool at the nozzle end and sucking it into the liquid channel are repeated by the decided number of times, to homogenize the mixed liquid quickly.

### FIELD OF THE INVENTION

The present invention relates to a method of homogenizing micro-volume liquid, and an apparatus for this method. More specifically, the present invention relates to a method of homogenizing micro-volume liquid by forming a pool at an end of a suction nozzle, and an apparatus for this method.

### BACKGROUND OF THE INVENTION

In conventional automatic analyzers, mixing of different liquids, such as a reagent and a specimen, or a specimen and a diluent, has been done by pouring the different liquids in a reaction cell and then stirring them by a stirring rod. In another mixing method, the different liquids poured in a container are mixed by being repeatedly sucked and discharged into and out of a suction nozzle, as disclosed for example in Japanese Laid-open Patent Application No. Hei 7-239334. A mixing method has also been suggested for example in Japanese Laid-open Patent Application No. 2000-304754, wherein a suction nozzle has different internal diameters, and a plurality of liquids are mixed by being repeatedly moved into a transition zone between the different internal diameters.

However, the above mentioned conventional liquid mixing methods have a disadvantage that the liquids left so much on inner walls of the mixing container or the suction nozzle that it is difficult to homogenize the mixed liquid exactly or completely.

### SUMMARY OF THE INVENTION

In view of the foregoing, a primary object of the present invention is to provide a method of homogenizing micro-volume liquid, and an apparatus for this method, which homogenize the micro-volume liquid exactly and quickly.

To achieve the above and other objects, a method of homogenizing micro-volume liquid of the present invention comprises a sucking step of sucking a liquid into a liquid channel inside a suction nozzle; and a homogenizing step of sending the sucked liquid from the liquid channel to a nozzle end, to form a pool of the liquid at the nozzle end, and stir the liquid in the pool due to its own inertia.

The homogenizing step preferably comprises a step of reciprocating the sucked liquid between the liquid channel and the nozzle end, to form the pool a number of times.

The suction nozzle preferably has a widening portion in an intermediate position of the liquid channel, where internal diameter of the liquid channel increases in a direction opposite to the nozzle end. In that case, the homogenizing step further comprises a step of forming a pool of the liquid in the widening portion.

By sucking different kinds of liquids seriatim into the liquid channel, it is possible to mix the different kinds of liquids in the homogenizing step.

Preferably, the sucking step further comprises a step of sucking a gas before sucking the next one of the different kinds of liquids, to form liquid separation layers of the gas between the different kinds of liquids as sucked in the liquid channel.

The pool is formed to be a substantially spherical liquid drop.

According to the present invention, an apparatus for homogenizing micro-volume liquid comprises:

a liquid sucking and discharging mechanism;

a suction nozzle coupled to the liquid sucking and discharging mechanism; and

a controller for controlling the liquid sucking and discharging mechanism to suck a liquid into a liquid channel of the suction nozzle and then form a pool of the liquid at a nozzle end, thereby to homogenize the liquid.

Preferably, the controller controls the liquid sucking and discharging mechanism to reciprocate the sucked liquid between the liquid channel and the nozzle end, to form the pool a number of times.

According to a preferred embodiment, the suction nozzle has a widening portion in an intermediate position of the liquid channel, where internal diameter of the liquid channel increases in a direction opposite to the nozzle end, wherein the controller controls the liquid sucking and discharging mechanism to form a pool of the liquid in the widening portion.

Because the liquid is automatically stirred in the pool due to its own inertia, the liquid is homogenized more quickly and efficiently in comparison with the case where the liquid is simply reciprocated in the nozzle. Especially where the pool is formed to be a substantially spherical liquid drop, the liquid flows actively in the pool, promoting the homogenizing effect. The present invention efficiently stirs the liquid to homogenize it just by sucking and sending out the liquid using the simple apparatus. When mixing different liquids, the liquids come into contact with each other merely in the suction nozzle, and there is no need for any mixing container or stirring rod. Therefore, the liquid would not adhere to or remain on the mixing container or the stirring rod, so the volumes of the liquids to be mixed are exactly measured.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a schematic perspective view of a micro-volume liquid homogenizing apparatus according to an embodiment of the present invention;

FIG. 2 is a flow chart illustrating a micro-volume liquid mixing and homogenizing method, according to an embodiment of the present invention;

FIGS. 3A to 3E are explanatory diagram illustrating respective steps of the micro-volume liquid mixing and homogenizing method;

FIGS. 4A to 4F are explanatory diagram illustrating respective steps of the micro-volume liquid mixing and homogenizing method, according to another embodiment;

FIG. 5 is a perspective view of a suction nozzle using a disposable nozzle tip;

FIG. 6 is an explanatory diagram illustrating a comparative example of a micro-volume liquid mixing and homogenizing method; and

FIG. 7 is a graph showing relationships between the number of reciprocation of two kinds of liquids and density difference between the liquids, with respect to an embodiment of the present invention and the comparative example.

### DESCRIPTION OF THE PREFERRED EMBODIMENTS

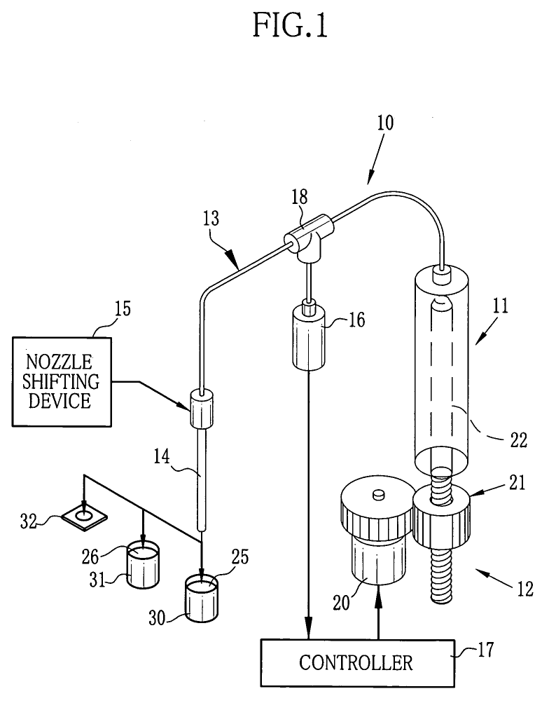

As FIG. 1 shows, a homogenizer of micro-volume liquids 10 consists of a syringe pump 11 as a liquid sucking discharging mechanism, a pump driver 12, an air tube 13, a suction nozzle 14, a nozzle shifting device 15, a pressure sensor 16 and a controller 17. Based on a signal from the pressure sensor 16, the controller 17 controls every part, to mix micro-volume liquids.

The suction nozzle 14 is placed with a nozzle end 14a downward and its nozzle top is connected to an end of the air tube 13. The other end of the air tube 13 is connected to the syringe pump 11, which is driven by the pump driver 12. The pump driver 12 consists of a motor 20 and a lead screw mechanism 21, which transforms spins of the motor 20 to reciprocating movements. Rotating the motor 20 forward or backward reciprocates a plunger 22 in the syringe pump 11 and then sucks or discharges liquids 25 and 26 or gas from the suction nozzle 14. The mechanism transforming the rotational movement of the motor 20 to the reciprocating movement of the plunger 22, however, is not limited to the lead screw mechanism 21. It is also possible to use a ball-screw mechanism, a rack and pinion mechanism or other mechanisms.

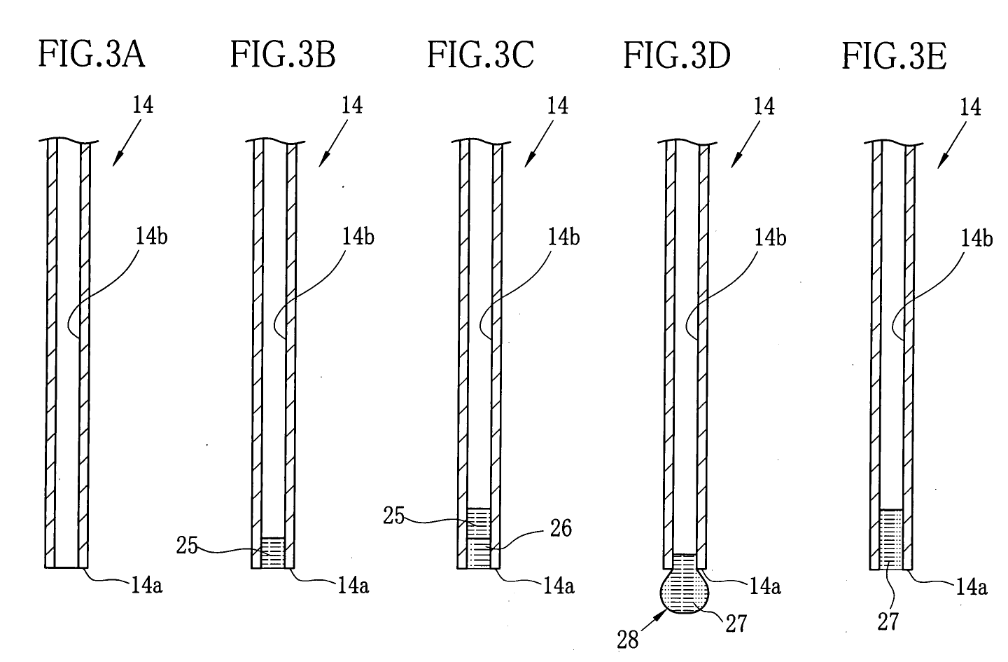

The nozzle shifting device 15 is provided with a vertical movement unit and a horizontal movement unit, both of which are not shown in the drawings. While the nozzle shifting device 15 moves the suction nozzle 14 horizontally and vertically among a first container 30 containing a first liquid 25, a second container 31 containing a second liquid 26 and a discharge position for discharging a mixture of the first and second liquids 25 and 26, the suction nozzle 14 sucks the first and second liquids 25 and 26 respectively from the first and second containers 30 and 31 into a liquid channel 14b, mixes the first and second liquids 25 and 26 and drops the mixed solution 27 (see in FIG. 3) on an examination chip 32 set in the discharge position.

The homogenizer of micro-volume liquids is installed in a biochemical analyzer used for example in medical institutions or laboratories. The biochemical analyzer puts a specimen droplet as a spot on the examination chip 32 such as a dry analysis element or an electrolyte slide (dry ion electrode film) and detects density of the substance by measuring the examination chip 32 with the droplet.

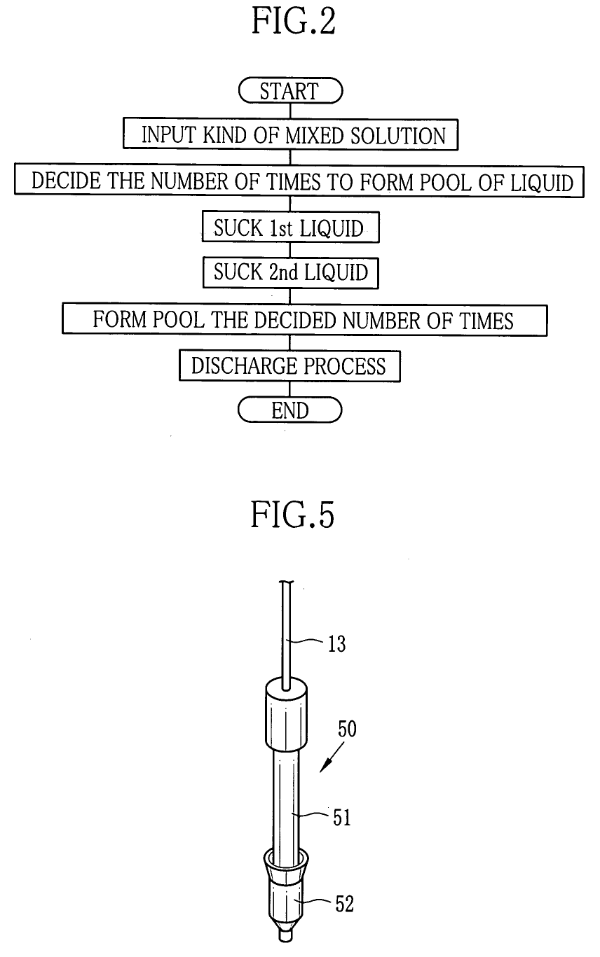

The controller 17 controls the motor 20 of the pump driver 12 and the nozzle shifting device 15, to mix the first and second liquid 25 and 26. The controller 17 receives a pressure signal from the pressure sensor 16, which is connected in the middle position of the air tube 13 through a branching tube 18, converts the pressure in the air tube 13 into an electronic signal and inputs the pressure signal to the controller 17. By controlling the nozzle shifting device 15 and the motor 20 based on the pressure signal, the controller 17 carries out such processes as shown in a flowchart of FIG. 2: sucking, mixing and discharging of the first and second liquids.

Next, the mixing process of the first and second liquids will be explained. First, as shown in FIG. 1, the nozzle shifting device 15 positions the suction nozzle 14 over the first container 30 with the first liquid 25, and then moves the suction nozzle 14 downward. During the downward movement of the suction nozzle 14, the syringe pump 11 starts sucking. When the end of the suction nozzle 14 touches the first liquid 25, the pressure detected by the pressure sensor 16 goes up, which indicates the touch on the liquid. Next the syringe pump 11 moves a given distance to change the suction nozzle 14 from a vacant state shown in FIG. 3A to a first suck state shown in FIG. 3B, where a given small amount of the first liquid 25, for example 2 μL, is sucked into the liquid channel 14b of the suction nozzle 14.

After sucking 2 μL of the first liquid 25, the nozzle shifting device 15 moves the suction nozzle 14 upward and then horizontally to position the suction nozzle 14 over the second container 31. Then the suction nozzle 14 goes down to suck for example only 2 μL of the second liquid 26 in the same way as the first liquid 25 as shown in FIG. 3C. After the suction of the second liquid 26, the plunger 22 in the syringe pump 11 moves and extrudes only 3 μL of the sucked first and second liquids 25 and 26 from the liquid channel 14b of the suction nozzle 14 as shown in FIG. 3D. The extrusion makes a pool 28 that is an almost spherical drop protruding from the suction nozzle end 14a just before dropping. The pool 28 does not drop but stays on the suction nozzle end 14a because of its surface tension to the suction nozzle end 14a. The form of the pool 28 makes the two liquids flow and stir by inertia inside the pool 28, which gets the first and second liquids 25 and 26 more fluid and promotes prompt mix of the two liquids 25 and 26. The shape of the pool 28 is not limited to the almost spherical drop just before dropping. The pool 28 may be semi-spherical or other shape, so the amount of extruding the liquid from the suction nozzle 14 may vary appropriately according to the viscosity of the liquid.

The circulation or stirring of the two liquids in the pool 28 converges in a given time. Then the syringe pump 11 sucks the pool 28 into the liquid channel 14b of the suction nozzle 14 as shown in FIG. 3E. The suck of the pool 28 reactivates the mixed solution to circulate and stir, which accelerates the two liquids 25 and 26 to mix better. Next, as shown in FIG. 3D, the mixed solution 27 of the first and second liquids 25 and 26 is pushed out from the liquid channel 14b of the suction nozzle 14 to form the pool 28 for the second time. Repeating forming the pools in the processes shown in FIGS. 3D and 3E promotes the mix of the first and second liquids 25 and 26. The smallest requisite number N of times to form the pools for completing stirring is previously detected according to the kinds of the first and second liquids 25 and 26, and stored in a memory 17a in the controller 17. So the number N of times to form the pools 28 is decided by designating the kinds of the first and second liquids 25 and 26. After the pools 28 are formed N times, the first and second liquids 25 and 26 are mixed to make the uniformly mixed solution 27.

Thereafter, the nozzle shifting device 15 moves the suction nozzle 14 to a position over the examination chip 32 that is placed in the measure position. Then, the mixed solution 27 is dropped on the examination chip 32 in the measure position. In the present embodiment, the amount of drop on the examination chip 32 is 4 μL, that is, all amount of the mixed solution 27 is dropped on the examination chip 32. The examination chip 32 is subjected to a photometric measurement by a chip detection sensor in the biochemical analyzer that is not shown in any drawings, and a photometry signal is sent from the chip detection sensor to the controller 17. Based on the photometry signal, the controller 17 carries out a predetermined biochemical analysis with reference to a correlation table between the photometry signal and the density of substance, which is previously memorized.

As known in the field of biochemical analysis, it is general to use the examination chip 32 such as a dry analysis element or an electrolyte slide (dry ion electrode film) for quantitative analysis of a certain chemical or formed components contained in a specimen only by providing the specimen droplet as a spot. The quantitative analysis of the chemical components or the like in the specimen is performed by colorimetry with the dry analysis element or potentiometory with the electrolyte slide.

In the biochemical analysis process using the colorimetry, color reaction (pigment producing reaction) is effected on the specimen put as a spot on the dry analysis element while be held at a constant temperature for a given time in an incubator, and a measuring light including predetermined wavelengths is illuminated to the dry analysis element to measure its optical density, from which the density of biochemical substance is found. On the other hand, in the biochemical analysis process using the potentiometory, the density of substance is gained through the quantitative analysis of certain ion activity, instead of the optical density. The quantitative analysis of certain ion activity is done by contacting a pair of the same dry ion electrodes to the specimen put on the electrolyte slide.

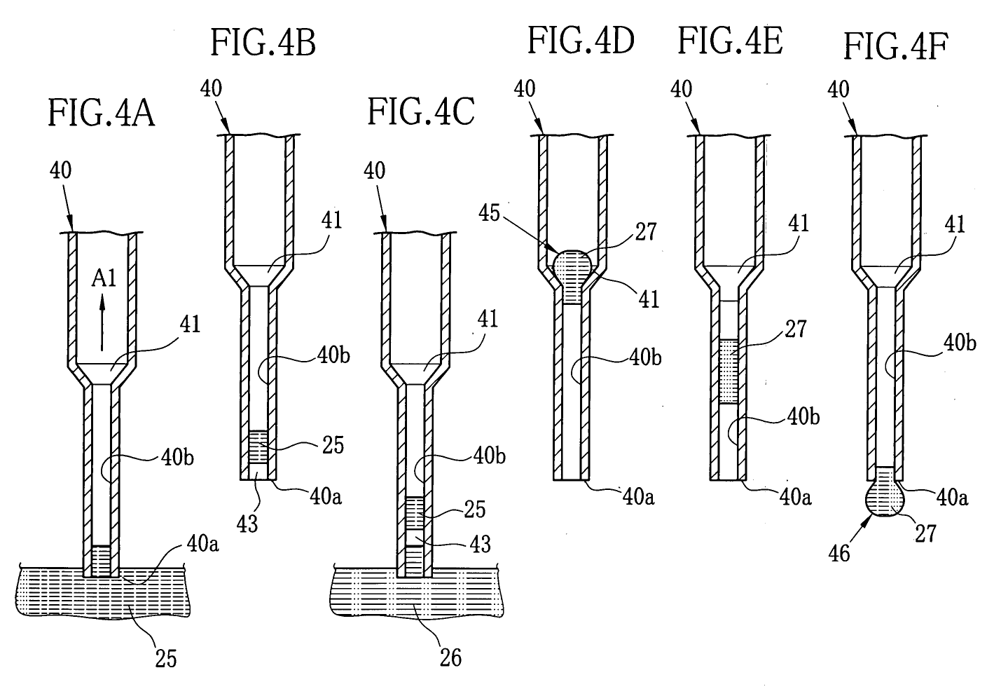

FIG. 4 illustrates a suction nozzle and a homogenization method according to another embodiment. In this embodiment, a liquid channel 40b of a suction nozzle 40 has a conical widening portion 41. The widening portion 41 gets wider and bigger along a sucking direction shown by an arrow A1 in the liquid channel 40b.

According to the present embodiment, the suction nozzle 40 sucks for example only 2 μL of a first liquid 25 as shown in FIG. 4A. Next, 1 μL of air is sucked in the state that a suction nozzle end 40a is away from the first liquid 25 as shown in FIG. 4B. After the suction nozzle end 40a comes into contact with a second liquid 26, the suction nozzle 40 sucks only 2 μL of the second liquid 26 as shown in FIG. 4C. Because the suction nozzle 40 has an air space 43 which blocks the contact between the first and second liquids 25 and 26, it prevents the first liquid 25 in the suction nozzle 40 from mixing in and contaminating the second liquid 26 in a second container. As shown in FIG. 4D, air is then sucked while the suction nozzle end 40a is set away from the second liquid 26 in the second container, so that a pool 45 of mixed solution 27 of the first and second liquids 25 and 26 is formed in the widening portion 41. Forming the pool 45 lets the first and second liquids 25 and 26 flow in the pool 45, to promote the mix of the first and second liquids 25 and 26.

Next, as shown in FIG. 4E, pneumatic extrusion from the suction nozzle 40 pushes the pool 45 of the mixed solution 27 into the liquid channel 40b. And another pool 46 is formed on the suction nozzle end 40a as shown in FIG. 4F. Forming the pool 46 lets the liquid flow in the pool 46, to promote the first and second liquids 25 and 26 to mix efficiently. As shown in FIG. 4E, the pool 46 is then sucked from,the suction nozzle end 40a into the liquid channel 40b. Repeating the processes shown in FIGS. 4D, 4E, 4F and 4E a given number of times stimulates mixing the first and second liquids 25 and 26 and thus guarantees the prompt mixing.

According to the embodiment, the air space 43 between the first and second liquids 25 and 26 prevents the first liquid 25 from coming into contact with the second liquid 26 on sucking the second liquid 26 from the second container, and thus prevents the first liquid 25 contaminating the second liquid 26 in the second container. Moreover forming pools alternately in the widening portion 41 and on the suction nozzle end 40a ensures mixing the liquids more promptly, efficiently and uniformly.

Note that because an opening space of the suction nozzle is very small, i.e. about one square millimeter, even if the suction nozzle 40 comes into contact with the second liquid just after sucking the first liquid, the contamination of the second liquid by the first liquid is small. Therefore, where the influence of the contamination is little, it is possible to omit the air space. Although the widening portion 41 is conical, any spreading angle is available within 180 degrees.

Because the pool 45 in the widening portion 41 is mixed in a hermetically-closed space, evaporation of the liquid is suppressed, so the liquid is mixed more accurately in comparison with the pool 46 on the suction nozzle end 40a. Accordingly, for making a mixed solution that is more likely to evaporate, the pools have to be formed in the widening portion 41 more frequently than at the suction nozzle end. If necessary, it is also possible to mix the liquids in the pools only in the widening portion 41. On the contrary, it is also possible to use the widening portion 41 only for degassing the air space 43, wherein two liquids is mixed and homogenized only in the pool 46 at the suction nozzle end 40a. In this case, adhesion of the liquid to inner wall of the widening portion 41 is reduced, so the accuracy of mixing is improved. It is also possible to provide more than one widening portion 41 in the liquid channel 40b.

As an example of liquids to be mixed, a combination of a specimen (e.g. urine or blood) and a reagent or diluent (e.g. water) may be referred to. In order to prevent a first liquid from mixing in a second liquid when sucking the second liquid, it is better to choose the liquid that needs to avoid the contamination as the first liquid.

In the above-described embodiments, because the suction nozzle 14 or 40 directly sucks the first and second liquids 25 and 26, a wash process is carried out as required before the next mixing process. Instead of this, as shown in FIG. 5, it is possible to stick a nozzle tip 52 on an end of a suction nozzle body 51 to constitute a suction nozzle 50, to mix liquids using a liquid channel in the nozzle tip 52. After the mixing process, the used nozzle tip 52 is discarded and another new nozzle tip 52 is stuck on the suction nozzle body 51 for the next mixing process.

A shape of the suction nozzle end or diameter of the liquid channel changes as necessary according to properties of plural liquids to be mixed, including their gravity, viscosity and surface tension. An acceptable diameter of the liquid channel in the suction nozzle is from 0.1 to 3.0 millimeters, especially from 0.3 to 1.0 millimeter. It is, therefore, desirable to choose an appropriate nozzle tip 52 according to the kinds of liquids to be mixed, from among plural kinds of nozzle tips 52 prepared for various kinds of mixed liquids.

In the above described embodiment, the first and second liquids 25 and 26 are sucked 2 μL respectively, and about 3 μL of the sucked liquids is extruded from the liquid channel 14b to form the pool 28. The volume of the pool, however, is not limited to the above-described embodiment. The volume of the pool may be changed according to the kind of liquids to be mixed. For example the volume of the pool (the total volume of the mixed solution protruding downward from the suction nozzle end) is from 5% to 95% of the total volume of the mixed solution, and preferably from 30% to 90%.

Although it is not shown in the drawings, it is also possible to gain stirring effects and to mix and homogenize plural liquids more promptly by placing such a minute hindering device as helical thread in the liquid channel of the suction nozzle. Instead of the helical thread, it is possible to form annular thread, helical grooves, annular grooves and projections. Moreover, instead of the hindering device, it is possible to raise homogenization effects of the liquids by bending the liquid channel.

Although the above-described embodiments explain the mixing of two kinds of liquids, the number of liquids to mix is not limited to two. More than two kinds of liquids can be mixed. The present invention is also applicable to homogenization of a liquid whose components are non-homogenized. In this case, only one liquid is sucked to form a pool to stimulate the homogenization.

In the above-described embodiments, the mixed solution is analyzed by the spotting method where a liquid to analyze is put as a spot on the analysis element after the homogenization process. The analysis, however, is not limited to the spotting method. It is possible to analyze based on the density or other values of the pool that are directly measured from lights transmitted through or reflected from the pool.

Experiment

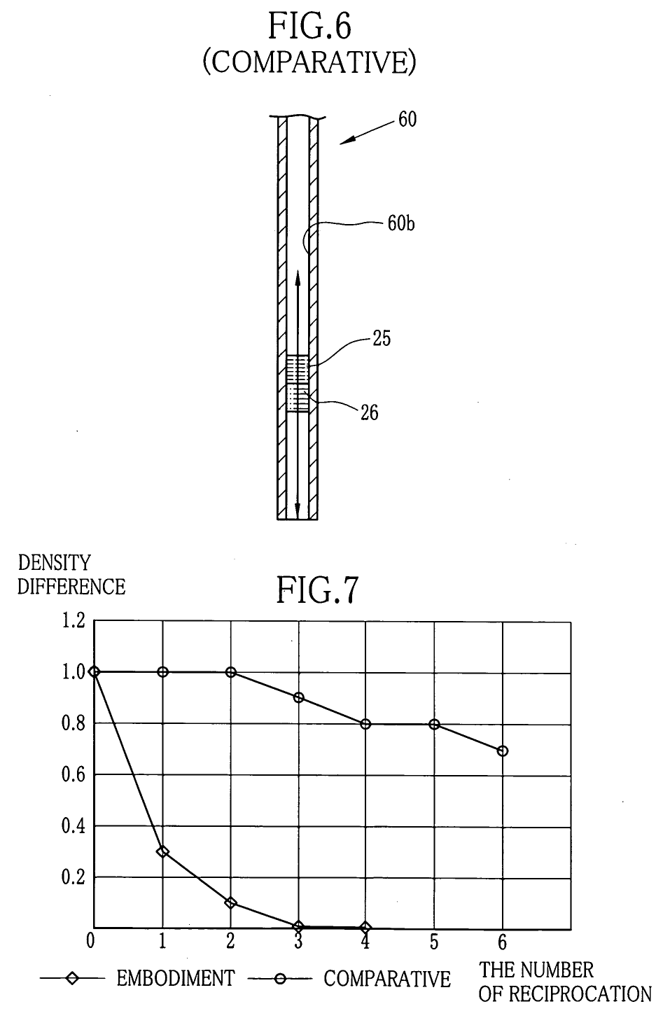

To confirm the stirring effects of forming the pools in the micro-volume liquid homogenizing method of the present invention, the stirring effects of the embodiment shown in FIG. 3 is compared with a comparative example wherein the first and second liquids 25 and 26 are merely moved up and down in a liquid channel 60b of a suction nozzle 60 as shown in FIG. 6. Using water as the first liquid, and black ink water whose optical density is different by 1.0 from that of the first liquid as the second liquid, a density difference of the mixed liquid between top and bottom of the nozzle is measured at each lap of reciprocation of the liquid in the liquid channel 14b as well as in the liquid channel 60b. FIG. 7 is a graph showing the results. As for the comparative example, the density difference is little reduced, that means the liquids is hardly mixed even while the reciprocation is done many times. On the other hand, in the embodiment of the present invention, the density difference between the top and the bottom of the nozzle 14 is reduced to 0.3 just by forming the pool once (that is, by one lap of reciprocation, and is reduced to 0.1 by forming the pool twice. By forming the pool three times, the density difference gets closer to zero, which means that the liquid is mixed almost evenly.

### INDUSTRIAL APPLICABILITY

In addition to a biochemical analyzer as explained in the above described embodiment, the micro-volume liquid homogenizing method and apparatus of the present invention is applicable to an analyzer of micro-TAS, nucleic acid extraction or immune assay that needs to mix micro-volume liquids of less 100 μL, especially from 1 μL to 20 μL, and also to various fields using mixed micro-volume liquids.

Thus the present invention is not to be limited to the above-described embodiments, but various modifications will be possible without departing from the scope of claims as appended hereto.

What is claimed is:

1. A method of homogenizing micro-volume liquid comprising:
a sucking step of sucking a liquid into a liquid channel inside a suction nozzle; and
a homogenizing step of sending the sucked liquid from said liquid channel to a nozzle end, to form a pool of the liquid at said nozzle end, and stir the liquid in the pool due to its own inertia.

2. A method of homogenizing micro-volume liquid as claimed in claim 1, wherein said homogenizing step comprises a step of reciprocating the sucked liquid between said liquid channel and said nozzle end, to form the pool a number of times.

3. A method of homogenizing micro-volume liquid as claimed in claim 1, wherein said suction nozzle has a widening portion in an intermediate position of said liquid channel, where internal diameter of said liquid channel increases in a direction opposite to said nozzle end, and wherein said homogenizing step further comprises a step of forming a pool of the liquid in said widening portion.

4. A method of homogenizing micro-volume liquid as claimed in claim 1, wherein said sucking step comprises a step of sucking different kinds of liquids seriatim into said liquid channel, to mix the different kinds of liquids in said homogenizing step.

5. A method of homogenizing micro-volume liquid as claimed in claim 4, wherein said sucking step further comprises a step of sucking a gas before sucking the next one of the different kinds of liquids, to form liquid separation layers of the gas between the different kinds of liquids as sucked in said liquid channel.

6. A method of homogenizing micro-volume liquid as claimed in claim 1, further comprising a step of discharging the liquid homogenized in said homogenizing step.

7. A method of homogenizing micro-volume liquid as claimed in claim 2, wherein the number of times to form the pool is predetermined according to the kind of the liquid.

8. A method of homogenizing micro-volume liquid as claimed in claim 3, wherein said homogenizing step comprises a step of reciprocating the sucked liquid between said widening portion and said nozzle end, to form the pool a number of times predetermined according to the kind of the liquid.

9. A method of homogenizing micro-volume liquid as claimed in claim 4, wherein said homogenizing step comprises a step of reciprocating the sucked liquids between said liquid channel and said nozzle end, to form the pool a number of times predetermined according to the kinds of the liquids.

10. A method of homogenizing micro-volume liquid as claimed in claim 1, wherein the pool is formed to be a substantially spherical liquid drop.

11. An apparatus for homogenizing micro-volume liquid comprising:
a liquid sucking and discharging mechanism;
a suction nozzle coupled to said liquid sucking and discharging mechanism; and
a controller for controlling said liquid sucking and discharging mechanism to suck a liquid into a liquid channel of said suction nozzle and then form a pool of the liquid at a nozzle end, thereby to homogenize the liquid.

12. An apparatus for homogenizing micro-volume liquid as claimed in claim 11, wherein said controller controls said liquid sucking and discharging mechanism to reciprocate the sucked liquid between said liquid channel and said nozzle end, to form the pool a number of times.

13. An apparatus for homogenizing micro-volume liquid as claimed in claim 11, wherein said suction nozzle has a widening portion in an intermediate position of said liquid channel, where internal diameter of said liquid channel increases in a direction opposite to said nozzle end, and wherein said controller controls said liquid sucking and discharging mechanism to form a pool of the liquid in said widening portion.

14. An apparatus for homogenizing micro-volume liquid as claimed in claim 13, wherein said controller controls said liquid sucking and discharging mechanism to reciprocate the sucked liquid between said widening portion and said nozzle end, to form the pool a number of times at said widening portion and said nozzle end.

15. An apparatus for homogenizing micro-volume liquid as claimed in claim 11, wherein said apparatus sucks different kinds of liquids seriatim into said liquid channel, to mix the different kinds of liquids in the pool.

16. An apparatus for homogenizing micro-volume liquid as claimed in claim 15, wherein said apparatus sucks a gas before sucking the next one of the different kinds of liquids, to form liquid separation layers of the gas between the different kinds of liquids as sucked in said liquid channel.

17. An apparatus for homogenizing micro-volume liquid as claimed in claim 11, wherein said controller controls said liquid sucking and discharging mechanism to discharge the liquid from said suction nozzle, after the liquid is homogenized.
